(19) United States
(12) Patent Application Publication
(10) Pub. No.: US 2024/0046101 A1
(43) Pub. Date: Feb. 8, 2024

(54) NEURAL NETWORK CONSTRUCTION DEVICE, NEURAL NETWORK CONSTRUCTION METHOD, IMAGE PROCESSING DEVICE, AND IMAGE PROCESSING METHOD

(71) Applicant: MITSUBISHI ELECTRIC CORPORATION, Tokyo (JP)

(72) Inventors: Genki TANAKA, Tokyo (JP); Takumi SATO, Tokyo (JP)

(73) Assignee: MITSUBISHI ELECTRIC CORPORATION, Tokyo (JP)

(21) Appl. No.: 18/381,703

(22) Filed: Oct. 19, 2023

Related U.S. Application Data
(63) Continuation of application No. PCT/JP2021/022425, filed on Jun. 14, 2021.

(51) Int. Cl. G06N 3/082

(52) U.S. Cl. CPC G06N 3/082

(57) ABSTRACT

When a first determination unit determines that a total necessary time does not satisfy a requested necessary time, or when a second determination unit determines that accuracy of inference does not satisfy requested inference accuracy, a generation unit generates a second operation combination different from a first operation combination.

### CROSS REFERENCE TO RELATED APPLICATIONS

This application is a Continuation of PCT International Application No. PCT/JP2021/022425 filed on Jun. 14, 2021, which is hereby expressly incorporated by reference into the present application.

### TECHNICAL FIELD

The present disclosure relates to a neural network construction device, a neural network construction method, an image processing device, and an image processing method.

### BACKGROUND ART

A learning model generation device described in Patent Literature 1, which is an example of a neural network construction device, replaces a layer constituting a learning model with a structure in which an operation amount is reduced, in order to suppress a decrease in accuracy of recognition or the like by the learning model even if computational resources of a computer for executing the learning model are relatively small.

### CITATION LIST

### Patent Literature

Patent Literature 1: JP 2020-107042 A

### SUMMARY OF INVENTION

### Technical Problem

Since the above-described learning model generation device reduces the operation amount of the above-described learning model, the accuracy of recognition or the like originally requested for the learning model is satisfied. However, there is a problem that the speed, that is, the necessary time originally requested for the learning model may not be satisfied.

An object of the present disclosure is to provide a neural network construction device capable of constructing a neural network model that satisfies both a necessary time and accuracy for inference, which are originally requested, even if resources for executing a learning model are relatively small.

### Solution to Problem

In order to solve the above problem, there are included a processor to execute a program; and a memory to store the program which, when executed by the processor, performs processes of, specifying a plurality of operations allocatable to a plurality of layers constituting a neural network model on the basis of a construction condition for constructing the neural network model, generating a first operation combination by allocating a corresponding one of the plurality of operations to each of the plurality of layers, determining whether or not a total necessary time which is inferred on the basis of the allocated operations and which is a total of necessary times of the respective operations satisfies a predetermined requested necessary time, training the neural network model having the generated first operation combination, determining whether or not accuracy of inference by the neural network model after the training satisfies predetermined requested inference accuracy, and when it is determined that the total necessary time does not satisfy the requested necessary time, or when it is determined that the accuracy of the inference does not satisfy the requested inference accuracy, generating a second operation combination different from the first operation combination.

### Advantageous Effects of Invention

With the neural network construction device according to the present disclosure, it is possible to construct a neural network model that satisfies both a necessary time and accuracy for inference, which are originally requested, even if resources for executing a learning model are relatively small.

### BRIEF DESCRIPTION OF DRAWINGS

FIG. 1 is a functional block diagram of a neural network construction device NNK of a first embodiment.

FIG. 2 illustrates a basic configuration of a neural network model NNM of the first embodiment.

FIG. 3 illustrates a configuration of a storage unit KI of the first embodiment.

FIG. 4 illustrates a configuration of a table TB of the first embodiment.

FIG. 5 illustrates a configuration of the neural network construction device NNK of the first embodiment.

FIG. 6 is a flowchart illustrating an operation of the neural network construction device NNK of the first embodiment.

FIG. 7 illustrates an operation of a generation unit SE of the first embodiment.

FIG. 8 illustrates an operation of a first determination unit HA1 of the first embodiment.

FIG. 9 illustrates an operation of a training unit KU of the first embodiment.

FIG. 10 is a functional block diagram of a neural network construction device NNK of a second embodiment.

FIG. 11 is a flowchart illustrating an operation of the neural network construction device NNK of the second embodiment.

FIG. 12 illustrates functions of an image processing device GSS of a third embodiment.

### DESCRIPTION OF EMBODIMENTS

Embodiments of a neural network construction device and an image processing device according to the present disclosure will be described.

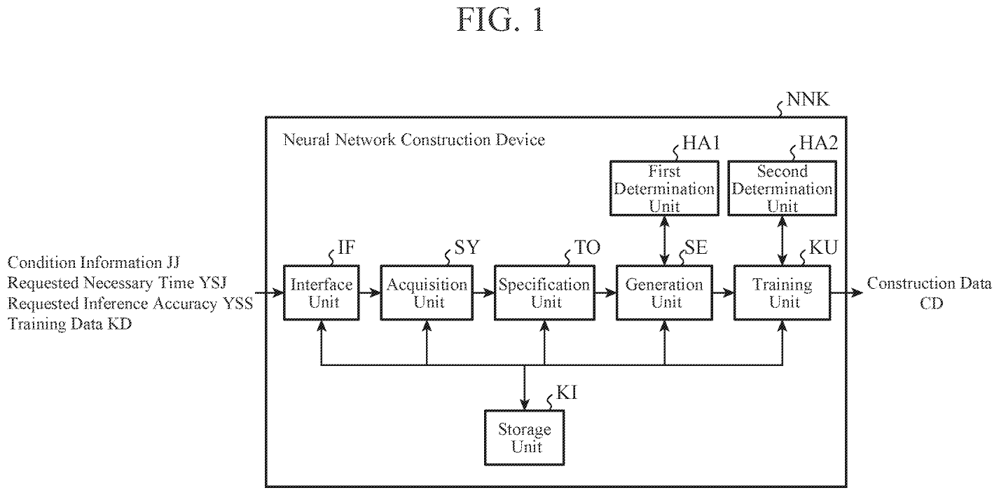

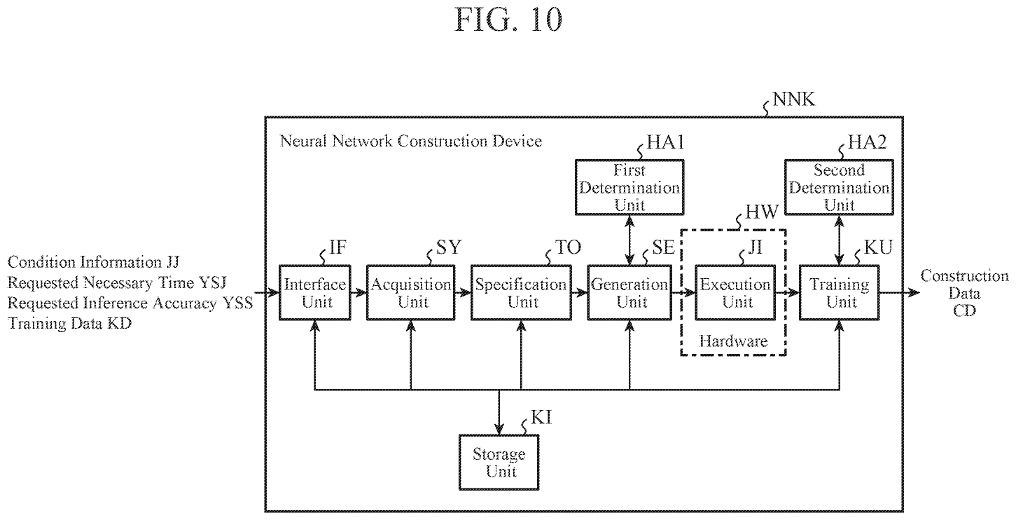

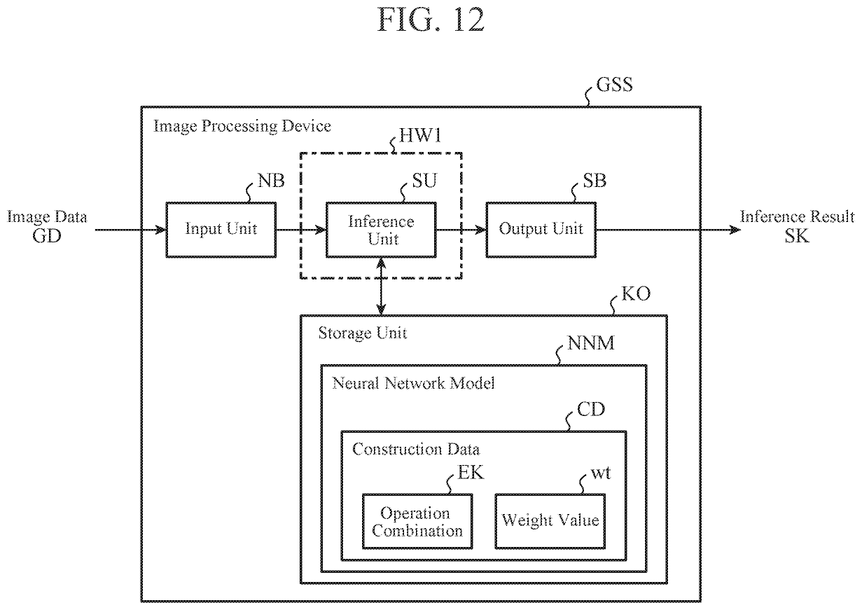

Neural network construction devices NNK (illustrated in FIG. 1 and FIG. 10) of first and second embodiments are devices in a learning phase, while an image processing device GSS (illustrated in FIG. 12) of a third embodiment is a device in an inference phase.

### First Embodiment

### First Embodiment

The neural network construction device NNK of the first embodiment will be described.

### Function of Neural Network Construction Device NNK

FIG. 1 is a functional block diagram of the neural network construction device NNK of the first embodiment.

As illustrated in FIG. 1, the neural network construction device NNK of the first embodiment includes a storage unit KI, an interface unit IF, an acquisition unit SY, a specification unit TO, a generation unit SE, a training unit KU, a first determination unit HA1, and a second determination unit HA2 in order to construct a neural network model NNM that performs a task (for example, class classification, object detection, localization, and segmentation).

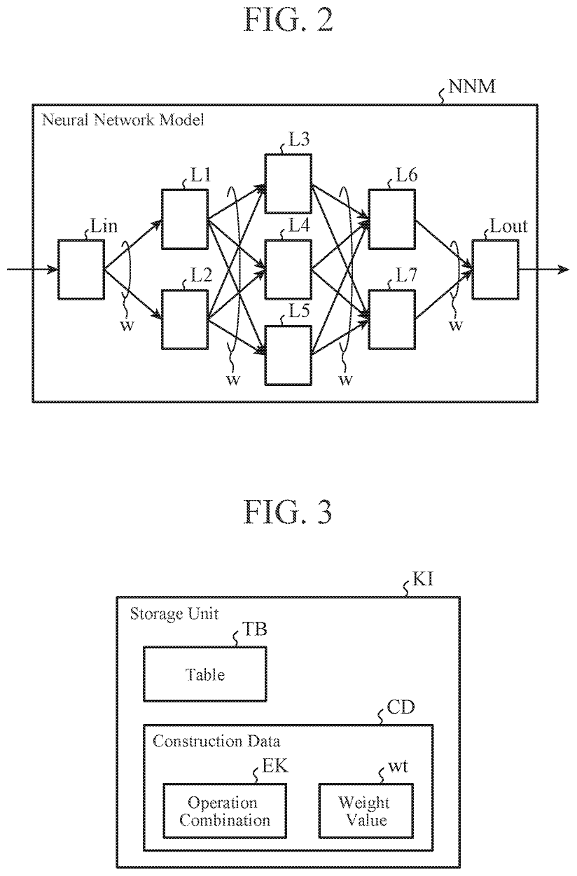

FIG. 2 illustrates a basic configuration of the neural network model NNM of the first embodiment.

### Configuration of Neural Network Model NNM

As illustrated in FIG. 2, the neural network model NNM includes, for example, an input layer Lin, an output layer Lout, seven intermediate layers L1 to L7, and weights w between adjacent layers, as conventionally known.

Operations (not illustrated) are allocated to the input layer Lin and the output layer Lout in advance, and the operations thereof are fixed. An input/output relationship related to the operation (for example, the number of pieces of data input for the operation and the number of pieces of data output as a result of the operation) is determined in the process of constructing the neural network model NNM by the neural network construction device NNK (illustrated in FIG. 1).

Operations and input/output relationships are not allocated to the seven intermediate layers L1 to L7 in advance, and the operations and the input/output relationships thereof are determined in the process of constructing the neural network model NNM by the neural network construction device NNK.

A value of the weight w is determined in the process of constructing the neural network model NNM by the neural network construction device NNK.

Hereinafter, the value of the weight w is referred to as a “weight value wt”. Although the weight value wt is originally a unique value, the weight value wt collectively refers to a plurality of weight values for easy description and understanding.

### Configuration of Storage Unit KI

FIG. 3 illustrates a configuration of the storage unit KI of the first embodiment.

As illustrated in FIG. 3, the storage unit KI stores a table TB in advance. In the storage unit KI, construction data CD is stored in the process in which the neural network construction device NNK (illustrated in FIG. 1) constructs the neural network model NNM (illustrated in FIG. 2).

### Configuration of Table TB

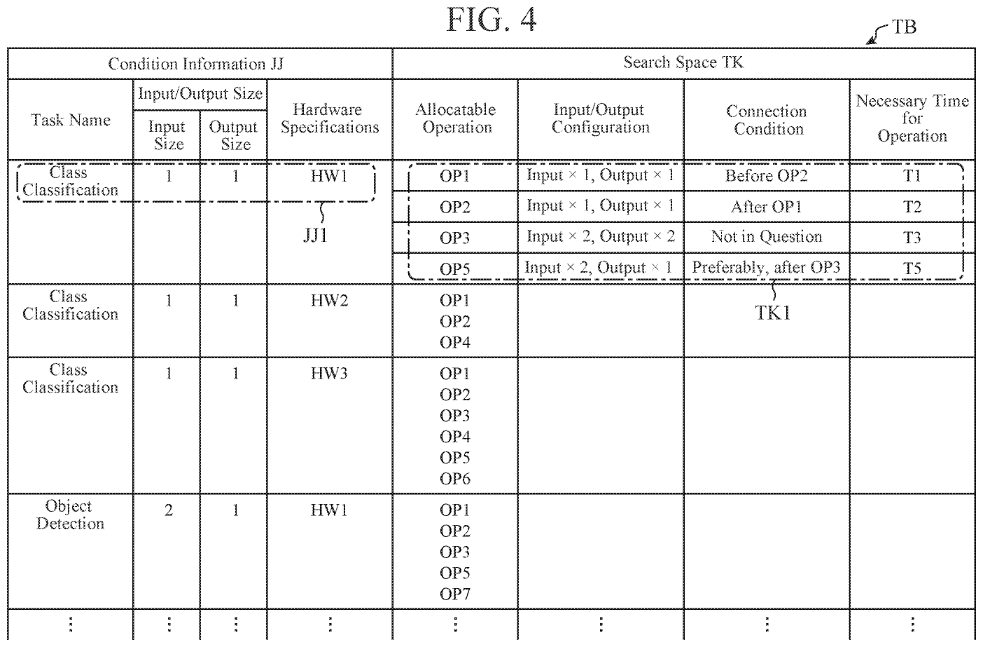

FIG. 4 illustrates a configuration of the table TB of the first embodiment.

As illustrated in FIG. 4, the table TB indicates a relationship between condition information JJ and a search space TK.

The condition information JJ includes conditions for constructing the neural network model NNM (illustrated in FIG. 2), and indicates, for example, a task name, an input/output size, and hardware specifications as illustrated in FIG. 4.

As described above, the task name is a possible task to be executed by the neural network model NNM (illustrated in FIG. 2), and is, for example, a name of class classification, object detection, localization, or segmentation.

The input/output size includes the number of pieces of data input to the input layer Lin and the number of pieces of data output from the output layer Lout when the neural network model NNM executes one of the tasks.

The hardware specifications are specifications of hardware that operates the neural network model NNM, and specifically includes a model of a computer, a type of processing (CPU/GPU/FPGA/DPU), and the like.

Instead of being stored in advance in the storage unit KI (illustrated in FIG. 3) in the neural network construction device NNK, the table TB may be stored in, for example, a storage device (not illustrated) outside the neural network construction device NNK, and may be acquired by the acquisition unit SY (illustrated in FIG. 1) via the interface unit IF (illustrated in FIG. 1).

The contents of the search space TK are specified by the condition information JJ. Specifically, as illustrated in FIG. 4, the search space TK indicates an operation that can be allocated to the intermediate layers L1 to L7 of the neural network model NNM (illustrated in FIG. 2), an input/output configuration of the operation, a connection condition of the operation, and a necessary time for the operation (necessary time which execution of the operation by the hardware specified by the condition information JJ takes).

### Configuration of Construction Data CD

As illustrated in FIG. 3, the construction data CD includes an operation combination EK and the weight value wt.

The operation combination EK indicates a combination of operations allocated to the intermediate layers L1 to L7 of the neural network model NNM. The weight value wt is a value of a weight between layers as described above with reference to FIG. 2.

### Function of Neural Network Construction Device NNK (Continued)

Returning to FIG. 1, the description will be continued.

The interface unit IF receives input of the condition information JJ (also illustrated in FIG. 4), a requested necessary time YSJ, requested inference accuracy YSS, and training data KD from a user (not illustrated) who intends to construct the neural network model NNM (illustrated in FIG. 2).

The requested necessary time YSJ and the requested inference accuracy YSS are the necessary time and the inference accuracy that are to be satisfied at the time of inference, that is, when the neural network model NNM actually performs a task.

The user inputs a request indicating that, for example, the neural network model NNM has to execute the task “class classification” (illustrated in FIG. 4) within the requested necessary time YSJ and with the requested inference accuracy YSS or higher.

The training data KD is data used when the neural network construction device NNK constructs the neural network model NNM, more specifically, when training is performed. The training data KD is labeled data for performing supervised learning, for example, as conventionally known.

The acquisition unit SY acquires the condition information JJ, the requested necessary time YSJ, the requested inference accuracy YSS, and the training data KD via the interface unit IF.

The specification unit TO specifies the search space TK by referring to the table TB (illustrated in FIG. 4) on the basis of the condition information JJ acquired by the acquisition unit SY. On the other hand, regardless of the content of the condition information JJ, the specification unit TO adds a Skip Connection operation and a No Connection operation (not illustrated) as allocatable operations in the search space TK.

For example, it is assumed that the acquisition unit SY acquires the condition information JJ of the task name “class classification”, the input size “1”, the output size “1”, and the hardware specifications “HW1” (hereinafter referred to as “condition information JJ1”), which are similar to those indicated by a dash-dot-dash line (left side) in FIG. 4, from the user. Under the assumption, the specification unit TO specifies the search space TK as indicated by a dash-dot-dash line (right side) in FIG. 4 (hereinafter referred to as a “search space TK1”) by referring to the table TB on the basis of the condition information JJ1.

The search space TK1 indicates the following under the condition information JJ1 described above.

(1) Four operations OP1, OP2, OP3, and OP5 can be allocated to the intermediate layers L1 to L7 (illustrated in FIG. 2) of the neural network model NNM.

(2) For example, in the operation OP1, the number of pieces of data input to the operation OP1 is one, and the number of pieces of data output from the operation OP1 is one.

(3) For example, the connection condition of the operation OP1 is that the operation OP1 is allocated to a position before the operation OP2.

(4) For example, when the operation OP1 is executed by the hardware HW1, the necessary time T1 is needed.

The operation OP1 and the like in the table TB include, for example, a Convolution operation and a Maxpooling operation which are conventionally well-known. In addition to the above operations, the operation OP1 and the like include, for example, the Skip Connection operation and the No Connection operation. The Skip Connection operation outputs input data as it is without performing any processing, and the No Connection operation does not output any data even if some data is input.

Hereinafter, in order to facilitate description and understanding, it is assumed that the necessary time Tl or the like of the operation OP1 or the like is fixed regardless of the internal structure of the operation OP1 or the like, the input/output relationship between the operation OP1 or the like and the outside, or the like. Thus, a total necessary time GSJ (as will be described in detail later) when the neural network model NNM executes the task “class classification” on the hardware HW1 under the condition information JJ1 is the sum of the necessary times T1, T2, T3, and T5 of the operations OP1, OP2, OP3, and OP5 allocated to the intermediate layers L1 to L7.

For example, the generation unit SE allocates the operation OP1 and the like to the intermediate layers L1 to L7 (illustrated in FIG. 2) of the neural network model NNM within the range of the search space TK1 (illustrated in FIG. 4) specified by the condition information JJ1 in such a way as to satisfy a requested necessary time YSJ1 which the neural network model NNM is required to achieve under the condition information JJ1. Thereby, the generation unit SE generates an operation combination EK (illustrated in FIG. 3). The generation unit SE generates the operation combination EK using, for example, random search, Bayesian optimization, or genetic algorithm. In the generation by the generation unit SE, for example, the number of times of generation and the time for generation are not particularly limited.

The training unit KU trains the neural network model NNM generated by the generation unit SE. More specifically, for example, the training unit KU trains the neural network model NNM in which the operation OP1 and the like in the search space TK1 (illustrated in FIG. 4) are allocated to the intermediate layers L1 to L7 (illustrated in FIG. 2) under the condition information JJ1 (illustrated in FIG. 4), and whose total necessary time GSJ, which is the sum of the necessary times of the allocated operation OP1 and the like, satisfies the requested necessary time YSJ1. The training unit KU performs training of the neural network model NNM using training data KD1 for the condition information JJ1 in such a way as to satisfy requested inference accuracy YSS1 which the neural network model NNM is required to achieve under the condition information JJ1. Thereby, the training unit KU generates the weight value wt (illustrated in FIG. 3). The training unit KU performs the training using, for example, a stochastic gradient descent method. In the training by the training unit KU, for example, the number of times of training and the time for training are not particularly limited.

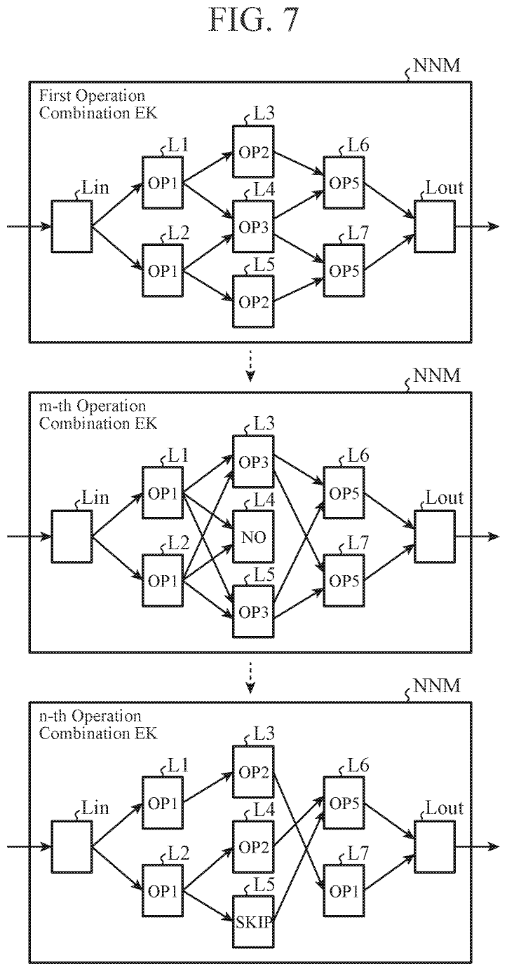

The first determination unit HA1 determines whether or not the necessary time of the neural network model NNM (illustrated in FIG. 7) for which the operation combination EK is generated by the generation unit SE satisfies the requested necessary time YSJ.

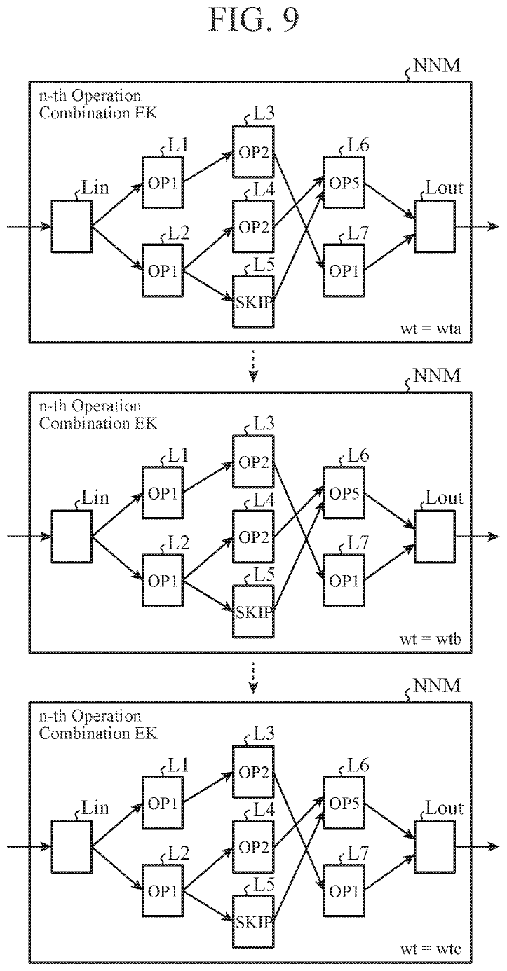

The second determination unit HA2 determines whether or not the inference accuracy of the neural network model NNM (illustrated in FIG. 9) trained by the training unit KU satisfies the requested inference accuracy YSS.

The neural network construction device NNK may be, for example, either a centralized system or a distributed system.

The specification unit TO corresponds to a “specification unit”, the generation unit SE corresponds to a “generation unit”, the first determination unit HA1 corresponds to a “first determination unit”, the second determination unit HA2 corresponds to a “second determination unit”, and the training unit KU corresponds to a “training unit”. The condition information JJ corresponds to a “construction condition”.

### Configuration of First Embodiment

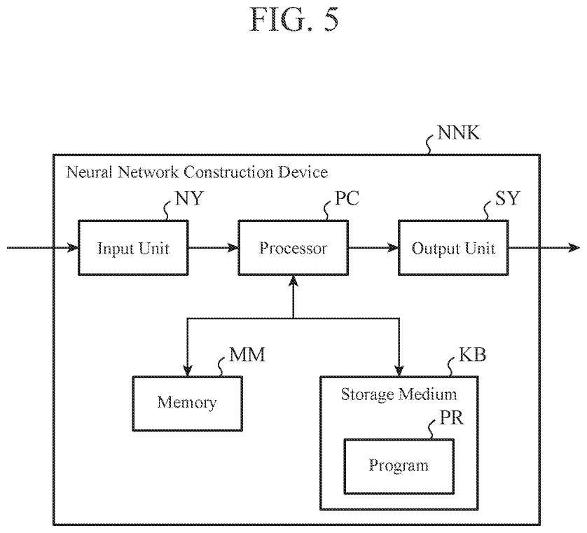

FIG. 5 illustrates a configuration of the neural network construction device NNK of the first embodiment.

As illustrated in FIG. 5, the neural network construction device NNK of the first embodiment includes a processor PC, a memory MM, and a storage medium KB, and further includes an input unit NY and an output unit SY as necessary to perform the above-described functions.

The processor PC is the well-known core of a computer that operates hardware in accordance with software. The memory MM includes, for example, a dynamic random access memory (DRAM) and a static random access memory (SRAM). The storage medium KB includes, for example, a hard disk drive (HDD), a solid state drive (SSD), and a read only memory (ROM). The storage medium KB stores a program PR. The program PR is a command group that defines contents of processing to be executed by the processor PC. The input unit NY includes, for example, a keyboard, a mouse, and a touch panel. The output unit SY includes, for example, a liquid crystal monitor, a printer, and a touch panel.

With regard to the relationship between the function and the configuration of the neural network construction device NNK, on the hardware, the processor PC executes the program PR stored in the storage medium KB on the memory MM and controls operations of the input unit NY and the output unit SY as necessary, thereby implementing the functions of the respective units from the interface unit IF to the second determination unit HA2 (illustrated in FIG. 1).

### Operation of Neural Network Construction Device NNK

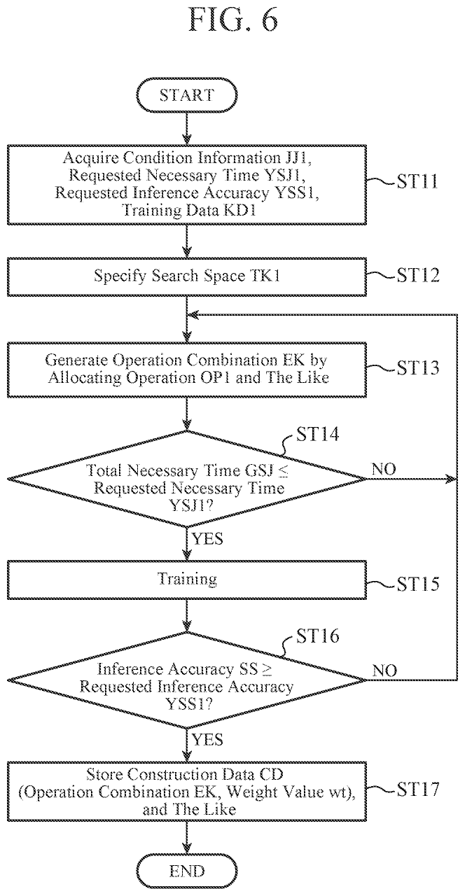

FIG. 6 is a flowchart illustrating an operation of the neural network construction device NNK of the first embodiment. Hereinafter, the operation of the neural network construction device NNK of the first embodiment will be described with reference to the flowchart of FIG. 6.

Hereinafter, in order to facilitate the description and understanding, it is assumed that the user inputs the condition information JJ1, the requested necessary time YSJ1, the requested inference accuracy YSS1, and the training data KD1 described above as the condition information JJ, the requested necessary time YSJ, the requested inference accuracy YSS, and the training data KD.

Step ST11: the acquisition unit SY (illustrated in FIG. 1) acquires the condition information JJ1, the requested necessary time YSJ1, the requested inference accuracy YSS1, and the training data KD1 via the interface unit IF (illustrated in FIG. 1).

Step ST12: when the condition information JJ1, the requested necessary time YSJ1, the requested inference accuracy YSS1, and the training data KD1 are acquired in step ST11, the specification unit TO (illustrated in FIG. 1) specifies the search space TK1 by referring to the table TB (illustrated in FIG. 4) on the basis of the acquired condition information JJ1.

FIG. 7 illustrates an operation of the generation unit SE of the first embodiment.

Step ST13: when the search space TK1 is specified in step ST12, the generation unit SE (illustrated in FIG. 1) allocates allocatable operations in the search space TK1 to the intermediate layers L1 to L7 of the neural network construction device NNK as illustrated in the upper part of FIG. 7. Specifically, the generation unit SE allocates the operation OP1 to the intermediate layer L1, allocates the operation OP1 to the intermediate layer L2, allocates the operation OP2 to the intermediate layer L3, allocates the operation OP3 to the intermediate layer L4, allocates the operation OP2 to the intermediate layer L5, allocates the operation OP5 to the intermediate layer L6, and allocates the operation OP5 to the intermediate layer L7. In other words, the generation unit SE generates the first operation combination EK of the operations OP1, OP1, OP2, OP3, OP2, OP5, and OP5 for the intermediate layers L1 to L7.

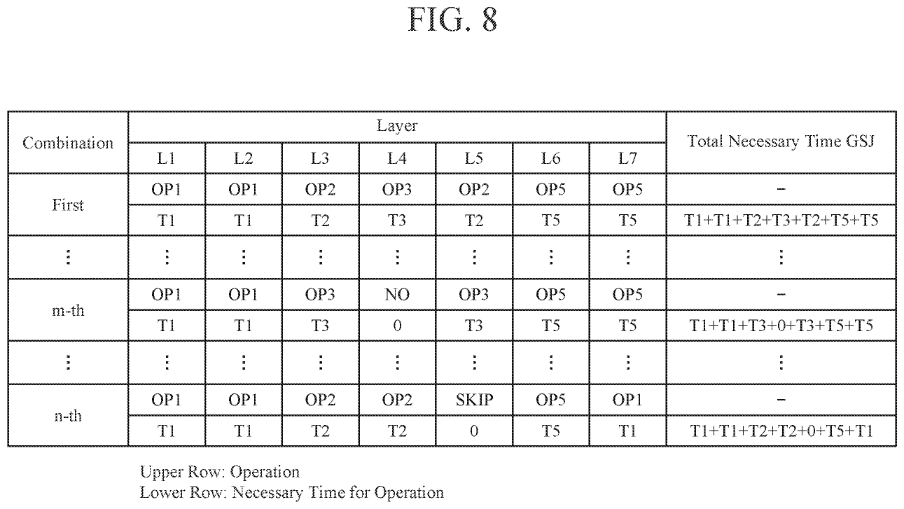

FIG. 8 illustrates an operation of the first determination unit HA1 of the first embodiment.

Step ST14: when the first operation combination EK is generated by allocating the operation OP1 and the like to the intermediate layers L1 to L7 in step ST13, the first determination unit HA1 calculates the total necessary time GSJ as illustrated in FIG. 8. As illustrated in FIG. 8, the first determination unit HA1 calculates the total necessary time GSJ (T1+T1+T2+T3+T2+T5+T5) by summing the necessary time T1 of the operation OP1 allocated to the intermediate layer L1, the necessary time T1 of the operation OP1 allocated to the intermediate layer L2, the necessary time T2 of the operation OP2 allocated to the intermediate layer L3, the necessary time T3 of the operation OP3 allocated to the intermediate layer L4, the necessary time T2 of the operation OP2 allocated to the intermediate layer L5, the necessary time T5 of the operation OP5 allocated to the intermediate layer L6, and the necessary time T5 of the operation OP5 allocated to the intermediate layer L7.

In addition to the above calculation, the first determination unit HA1 determines whether or not a necessary condition that the total necessary time GSJ (T1+T1+T2+T3+T2+T5+T5) is equal to or less than the requested necessary time YSJ1 acquired by the acquisition unit SY is satisfied. When it is determined that the condition is satisfied, the process proceeds to step ST15, and on the other hand, when it is determined that the condition is not satisfied, the process returns to step ST13.

Here, the following is assumed.

(1) The generation unit SE and the first determination unit HA1 repeat steps ST13 and ST14.
(2) After the repetition of (1), the generation unit SE allocates the operation OP1 to the intermediate layer L1, allocates the operation OP1 to the intermediate layer L2, allocates the operation OP3 to the intermediate layer L3, allocates the operation NO to the intermediate layer L4, allocates the operation OP3 to the intermediate layer L5, allocates the operation OP5 to the intermediate layer L6, and allocates the operation OP5 to the intermediate layer L7 as an m-th (m is any positive integer) operation combination EK, for example, as illustrated in the middle part of FIG. 7.
(3) After the generation of the m-th operation combination EK in (2), the first determination unit HA1 determines that the total necessary time GSJ (T1+T1+T3+0+T3+T5+T5) of the m-th operation combination EK satisfies the requested necessary time YSJ1.

“NO operation” means the No Connection operation. As described above, the “NO operation” has a function of outputting no data even when receiving input of some data. The necessary time of the “NO operation” is 0.

Step ST15: when it is determined in the immediately preceding step ST14 that the total necessary time GSJ (T1+T1+T3+0+T3+T5+T5) satisfies the requested necessary time YSJ1, the training unit KU (illustrated in FIG. 1) trains the neural network model NNM having the m-th operation combination EK (illustrated in the middle part of FIG. 7). More specifically, using the training data KD1 acquired by the acquisition unit SY, the training unit KU adjusts the weight w (illustrated in FIG. 2), to be precise, the weight value wt (illustrated in FIG. 3) in the neural network model NNM so that an error (not illustrated) between the data (not illustrated) output from the output layer Lout and the label (not illustrated) in the training data KD1 becomes smaller as conventionally known.

The training unit KU ends the above training after continuing the training for a predetermined time or a predetermined number of times, or ends the training after continuing the training depending on the progress of the learning effect by the training.

Step ST16: when the training of the neural network model NNM is completed in step ST15, the second determination unit HA2 (illustrated in FIG. 1) determines whether or not a necessary condition that the inference accuracy SS (not illustrated) of the trained neural network model NNM is equal to or higher than the requested inference accuracy YSS1 acquired by the acquisition unit SY is satisfied. When it is determined that the necessary condition is satisfied, the process proceeds to step ST17, and on the other hand, when it is determined that the necessary condition is not satisfied, the process returns to step ST13.

FIG. 9 illustrates an operation of the training unit KU of the first embodiment.

Here, the following is assumed.

(1) The generation unit SE, the first determination unit HA1, the training unit KU, and the second determination unit HA2 repeat steps ST13 to ST16.
(2) After the repetition of (1), the generation unit SE allocates the operation OP1 to the intermediate layer L1, allocates the operation OP1 to the intermediate layer L2, allocates the operation OP2 to the intermediate layer L3, allocates the operation OP2 to the intermediate layer L4, allocates the operation SKIP to the intermediate layer L5, allocates the operation OP5 to the intermediate layer L6, and allocates the operation OP1 to the intermediate layer L7 as an n-th (n is an integer greater than m) operation combination EK, for example, as illustrated in the lower part of FIG. 7.
(3) After generation of the n-th operation combination EK in (2), the first determination unit HA1 determines that the total necessary time GSJ (T1+T1+T2+T2+0+T5+T1) of the n-th operation combination EK satisfies the requested necessary time YSJ1.

“SKIP operation” means the Skip Connection operation. As described above, the “SKIP operation” has a function of outputting input data as it is without performing any processing. The necessary time of the “SKIP operation” is 0.

(4) After the determination of (3), the training unit KU adjusts the weight value wt of the neural network model NNM having the n-th operation combination EK, for example, sets the weight value wt to wta, then changes it to wtb, and then changes it to wtc.
(5) After the training of (4), the second determination unit HA2 determines that the inference accuracy SS of the n-th operation combination EK satisfies the requested inference accuracy YSS1.

Step ST17: when it is determined in the immediately preceding step ST16 that the inference accuracy SS of the neural network model NNM having the n-th operation combination EK satisfies the requested inference accuracy YSS1, the second determination unit HA2 stores the construction data CD, that is, the n-th operation combination EK (illustrated in the lower part of FIG. 7 and in FIG. 9) and the weight value wtc (illustrated in the lower part of FIG. 9) that is the weight value wt in the storage unit KI (illustrated in FIG. 3), or outputs them.

### Effects of Neural Network Construction Device NNK

As described above, in the neural network construction device NNK of the first embodiment, the allocatable operation OP1 and the like in the search space TK1 specified by the condition information JJ1 input by the user are allocated to the intermediate layers L1 to L7 of the neural network model NNM to be constructed. Thus, it is possible to increase the possibility of constructing the neural network model NNM that satisfies the requested necessary time YSJ1.

The neural network construction device NNK of the first embodiment also performs training using the training data KD1. Thus, it is possible to increase the possibility of constructing the neural network model NNM that satisfies the requested inference accuracy YSS1.

Further, in the neural network construction device NNK of the first embodiment, by allocating the No Connection operation and the Skip Connection operation to at least one or more of the intermediate layers L1 to L7 of the neural network model NNM, the number of layers that do not substantially function is increased, in other words, the number of layers that substantially function is reduced. Thereby, the overall operation amount of the neural network model NNM can be reduced.

The neural network construction device NNK of the first embodiment is mounted on a vehicle such as a private car in order to perform image processing for autonomous driving, for example. The neural network construction device NNK stores image data in advance at the manufacturing stage of the vehicle by the manufacturer. In addition, the neural network construction device NNK continues to accumulate image data at the traveling stage of the vehicle by the driver. The neural network construction device NNK can construct the neural network model NNM that executes the class classification for both the images described above, for example, the classification as to whether the detected object is a person, an animal, a tree, or the like, in such a way as to satisfy the requested necessary time YSJ1 and the requested inference accuracy YSS1 described above.

### Modification 1

Unlike the neural network construction device NNK of the first embodiment that sums the necessary times in the intermediate layers L1 to L7, the necessary times in the intermediate layers L1 to L7 and the necessary times in the input layer Lin and the output layer Lout to which the operation OP is not allocated may be summed to obtain the total necessary time GSJ, and then it may be determined whether or not the total necessary time GSJ satisfies the requested necessary time YSJ1.

### Modification 2

Unlike the neural network construction device NNK of the first embodiment that generates only the neural network model NNM having the n-th operation combination EK, for example, a plurality of operation combinations EK such as a p-th (p is an integer greater than n) operation combination EK, a q-th (q is an integer greater than p) operation combination EK, . . . may be generated. Then, the most excellent operation combination EK may be selected from the viewpoint of the requested necessary time YSJ1 and the requested inference accuracy YSS1 among the plurality of operation combinations EK, that is, the n-th operation combination EK, the p-th operation combination EK, and the q-th operation combination EK.

### Second Embodiment

### Second Embodiment

A neural network construction device NNK of a second embodiment will be described.

### Function of Neural Network Construction Device NNK

Unlike the case where the neural network construction device NNK of the first embodiment uses the total necessary time GSJ (illustrated in FIG. 8) of the necessary times for operations (prepared and assumed necessary times for operations) in the table TB (illustrated in FIG. 4) stored in the storage unit KI (illustrated in FIG. 1 and FIG. 3), the neural network construction device NNK of the second embodiment measures an actual necessary time JSJ that is the necessary time it takes for the neural network model NNM to actually perform the operations.

FIG. 10 is a functional block diagram of the neural network construction device NNK of the second embodiment.

As illustrated in FIG. 10, similarly to the neural network construction device NNK of the first embodiment (illustrated in FIG. 1), the neural network construction device NNK of the second embodiment includes each unit from the storage unit KI to the second determination unit HA2, and further includes an execution unit JI, unlike the neural network construction device NNK of the first embodiment.

The function of each unit from the interface unit IF to the second determination unit HA2 of the second embodiment is similar to that of each unit from the interface unit IF to the second determination unit HA2 of the first embodiment.

The execution unit JI is provided, for example, on hardware “HW1” specified by the condition information JJ1 (illustrated in FIG. 4). The execution unit JI actually operates, on the hardware “HW1”, in other words, on the execution unit JI, the neural network model NNM (illustrated in FIG. 2) in which the allocatable operation OP1 and the like in the search space TK1 specified by the condition information JJ1 are allocated to the intermediate layers L1 to L7, thereby measuring the actual necessary time JSJ of the neural network model NNM.

### Configuration of Neural Network Construction Device NNK

The configuration of the neural network construction device NNK of the second embodiment is similar to the configuration of the neural network construction device NNK of the first embodiment (illustrated in FIG. 5).

### Operation of Neural Network Construction Device NNK

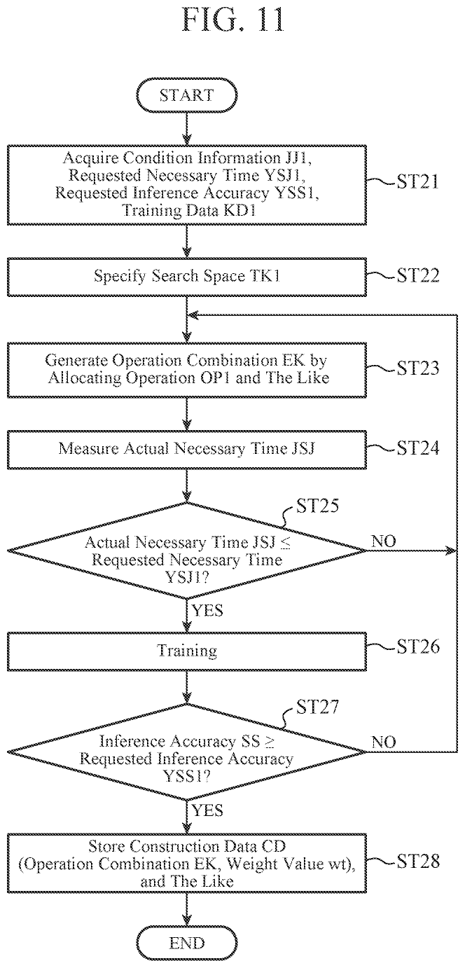

FIG. 11 is a flowchart illustrating an operation of the neural network construction device NNK of the second embodiment. Hereinafter, the operation of the neural network construction device NNK of the second embodiment will be described with reference to the flowchart of FIG. 11.

For ease of description and understanding, the following is assumed.

(1) As in the first embodiment, the user inputs the condition information JJ1, the requested necessary time YSJ1, the requested inference accuracy YSS1, and the training data KD. (2) As in the first embodiment, the n-th operation combination EK is generated after the first operation combination EK, the m-th operation combination EK, and the like.

Steps ST21 to ST23: the acquisition unit SY, the specification unit TO, and the generation unit SE perform processes similar to those in steps ST11 to ST13 of the first embodiment.

Step ST24: when the allocatable operation OP1 and the like in the search space TK1 specified by the condition information JJ1 are allocated to the intermediate layers L1 to L7 in step ST23, that is, when the neural network model NNM having the n-th operation combination EK (illustrated in the lower part of FIG. 7) is generated, the execution unit JI measures the actual necessary time JSJ by actually operating the neural network model NNM on the hardware HW1.

Step ST25: when the actual necessary time JSJ is measured in step ST24, the first determination unit HA1 determines whether or not the actual necessary time JSJ of the n-th operation combination EK satisfies the requested necessary time YSJ1.

Steps ST26 to ST28: the training unit KU and the second determination unit HA2 perform processes similar to those in steps ST15 to ST17 of the first embodiment.

### Effects of Neural Network Construction Device NNK

As described above, the neural network construction device NNK of the second embodiment measures and uses the actual necessary time JSJ of the neural network model NNM, for example, the actual necessary time JSJ when the neural network model NNM having the n-th combination actually operates on the hardware HW1. Thereby, it is possible to construct the neural network model NNM having a higher possibility of satisfying the requested necessary time YSJ1 as compared with the neural network model NNM of the first embodiment constructed using the necessary times for operations (illustrated in FIG. 4) stored in advance in the storage unit KI and estimated.

### Third Embodiment

### Third Embodiment

An image processing device of a third embodiment will be described.

### Function, Configuration, and Operation of Image Processing Device GSS

FIG. 12 illustrates functions of the image processing device GSS of the third embodiment.

As illustrated in FIG. 12, the image processing device GSS of the third embodiment includes a storage unit KO, an input unit NB, an inference unit SU, and an output unit SB.

The storage unit KO stores the neural network model NNM constructed under conditions such as the condition information JJ1 by the neural network construction device NNK of any one of the first embodiment and the second embodiment, more precisely, the n-th operation combination EK and the weight value wt.

The input unit NB is, for example, an imaging camera. The input unit NB acquires, for example, image data GD.

The inference unit SU is provided, for example, on the hardware HW1 specified by the condition information JJ1. The inference unit SU performs inference as conventionally known, and specifically, executes the neural network model NNM using the image data GD.

The output unit SB is, for example, a liquid crystal monitor, a speaker, or the like. The output unit SB outputs an inference result SK that is a result of the inference performed by the inference unit SU.

The storage unit KO corresponds to a “memory”, the input unit NB corresponds to a “camera”, the output unit SB corresponds to a “monitor or speaker”, the image data GD corresponds to “image data”, and the “inference result SK” corresponds to a “result of inference”.

### Effects of Image Processing Device GSS

As described above, the image processing device GSS of the third embodiment executes, on the hardware HW1 specified by the condition information JJ1, the neural network model NNM constructed by the neural network construction device NNK of the first or second embodiment and having the n-th operation combination EK satisfying the requested necessary time YSJ1 and the requested inference accuracy YSS1. Thus, it is possible to perform inference that satisfies the requested necessary time YSJ1 and the requested inference accuracy YSS1.

The above-described embodiments may be combined, components in each embodiment may be appropriately omitted or changed, or other components may be added, without departing from the gist of the present disclosure.

### INDUSTRIAL APPLICABILITY

The neural network construction device according to the present disclosure can be applied to a neural network construction device capable of constructing a neural network model that can satisfy the necessary time and accuracy for inference.

### REFERENCE SIGNS LIST

CD: construction data, EK: operation combination, GD: image data, GSJ: total necessary time, GSS: image processing device, HA1: first determination unit, HA2: second determination unit, HW: hardware, IF: interface unit, JI: execution unit, JJ: condition information, JSJ: actual necessary time, KB: storage medium, KD: training data, KI: storage unit, KO: storage unit, KU: training unit, L: intermediate layer, Lin: input layer, Lout: output layer, MM: memory, NB: input unit, NNK: neural network construction device, NNM: neural network model, NY: input unit, OP: operation, PR: program, SB: output unit, SE: generation unit, SK: inference result, SS: inference accuracy, SU: inference unit, SY: acquisition unit, SY: output unit, TB: table, TK: search space, TO: specification unit, w: weight, wt: weight value, YSJ: requested necessary time, YSS: requested inference accuracy.

1. A neural network construction device, comprising:
a processor to execute a program; and
a memory to store the program which, when executed by the processor, performs processes of, specifying a plurality of operations allocatable to a plurality of layers constituting a neural network model on a basis of a construction condition for constructing the neural network model;
generating a first operation combination by allocating a corresponding one of the plurality of operations to each of the plurality of layers;
determining whether or not a total necessary time which is inferred on a basis of the allocated operations and which is a total of necessary times of the respective operations satisfies a predetermined requested necessary time;
training the neural network model having the generated first operation combination;
determining whether or not accuracy of inference by the neural network model after the training satisfies predetermined requested inference accuracy; and
when it is determined that the total necessary time does not satisfy the requested necessary time, or when it is determined that the accuracy of the inference does not satisfy the requested inference accuracy, generating a second operation combination different from the first operation combination.

2. The neural network construction device according to claim 1, wherein the plurality of operations includes a skip connection operation that outputs input data as it is and a no-connection operation that does not output any data.

3. The neural network construction device according to claim 1, wherein the total necessary time includes a necessary time in a layer to which none of the plurality of operations has been allocated, and which is among the plurality of layers.

4. The neural network construction device according to claim 1,
wherein the processes further include:
executing the neural network model having the generated first operation combination under the construction condition; and
determining whether or not an actual necessary time which the execution of the neural network model having the generated first operation combination takes satisfies the predetermined requested necessary time.

5. An image processing device, comprising:
a memory to store a neural network model constructed by the neural network construction device according to claim 1;
a camera to acquire image data for the neural network model to perform inference; and
a monitor or a speaker to output a result of the inference by the neural network model.

6. A neural network construction method, comprising:
specifying a plurality of operations allocatable to a plurality of layers constituting a neural network model on a basis of a construction condition for constructing the neural network model;
generating a first operation combination by allocating a corresponding one of the plurality of operations to each of the plurality of layers;
determining whether or not a total necessary time which is inferred on a basis of the allocated operations and which is a total of necessary times of the respective operations satisfies a predetermined requested necessary time;
training the neural network model having the generated first operation combination;
determining whether or not accuracy of inference by the neural network model after the training satisfies predetermined requested inference accuracy; and
when it is determined that the total necessary time does not satisfy the requested necessary time, or when it is determined that the accuracy of the inference does not satisfy the requested inference accuracy, generating a second operation combination different from the first operation combination.

7. An image processing method, comprising:
storing a neural network model constructed by the neural network construction method according to claim 6;
receiving input of image data for the neural network model to perform inference; and
outputting a result of the inference by the neural network model.
